(19) United States
(12) Patent Application Publication
(10) Pub. No.: US 2023/0180712 A1
(43) Pub. Date: Jun. 15, 2023

(54) Frozen Pet Container for Licking Consumption by Pets

(71) Applicant: Thomas Matthew Straw, Sunrise Beach, TX (US)

(72) Inventor: Thomas Matthew Straw, Sunrise Beach, TX (US)

(21) Appl. No.: 18/082,184

(22) Filed: Dec. 15, 2022

Related U.S. Application Data
(60) Provisional application No. 63/361,401, filed on Dec. 15, 2021.

(51) Int. Cl. A01K 5/015

(52) U.S. Cl. CPC A01K 5/015

(57) ABSTRACT

A frozen pet container employs a frozen pet treat cup including a side wall adjoined to a floor defining a hemispherical cavity configured to conditionally form a frozen pet treat within the frozen pet treat cup. The frozen pet container further employs a frozen pet treat retainer disposed within the hemispherical cavity and adjoined to the side wall and/or the floor. The frozen pet treat retainer is configured to interactively retain the frozen pet treat conditionally formed within the frozen pet treat cup. To this end, the frozen pet treat retainer may include bracket(s) partially encircling the side wall and/or spike(s) extending from the side wall or the floor.

### CROSS REFERENCE

This application claims priority to U.S. Patent Application No. 63/361,401 filed on Dec. 15, 2021, the entire disclosure of which is incorporated herein by reference.

### FIELD OF THE INVENTION

The present disclosure generally describes exemplary embodiments of frozen pet treat containers designed to retain frozen pet treats for licking consumption by pets, particularly dogs. The present disclosure more particularly describes exemplary embodiments of a frozen pet treat container including bracket(s) and/or spike(s) for interactively retaining a frozen pet treat formed within the frozen pet treat cup for licking consumption by pets, particularly dogs.

### BACKGROUND OF THE INVENTION

Frozen pet treat containers currently in the marketplace include a frozen pet treat cup including a side wall adjoined to a floor defining a hemispherical cavity configured to conditionally form a frozen pet treat within the frozen pet treat cup for licking consumption by pets, particularly dogs. The frozen pet treat may be a snack/desert type of pet treat or a nutritional based pet treat that may incorporate medication(s) and/or supplement(s) within the pet treat.

A drawback of such known frozen pet treat containers is the licking force by a pet and digging teeth of the pet will tend to dislodge the frozen pet treat from the cup. For example, some frozen pet treat containers include vertical ridges extending from a rim of the cup along the side wall to the floor. However, these vertical ridges are not configured to interactively retain the frozen pet treat within the cup. Thus, a licking force by a pet or digging teeth of the pet will tend to dislodge the frozen pet treat from the cup.

### SUMMARY OF THE INVENTION

Exemplary inventive subject matter of the present disclosure include, but are not limited, (1) a frozen pet treat container designed to retain a frozen pet treat for licking consumption by pets, particularly dogs and (2) a frozen pet treat tray including frozen pet treat container(s) designed to retain frozen pet treat(s) for licking consumption by pets, particularly dogs. A frozen pet treat may consist of any food edible by a pet. A frozen pet treat tray of the present disclosure may be used to transfer frozen pet treat containers unfrozen pet treats to a freezer and to transfer frozen pet treat containers with frozen pet treats from the freezer. Additionally, a frozen pet treat tray of the present disclosure may be used to position the frozen pet treat containers on a surface that facilitates licking consumption by pets.

Various embodiments of a frozen pet container of the present disclosure employs

(1) a frozen pet treat cup including a side wall adjoined to a floor defining a hemispherical cavity configured to conditionally form a frozen pet treat within the frozen pet treat cup, and (2) a frozen pet treat retainer disposed within the hemispherical cavity and adjoined to at least one of the side wall and the floor. The frozen pet treat retainer is configured to interactively retain the frozen pet treat conditionally formed within the frozen pet treat cup. To this end, the frozen pet treat retainer may include bracket(s) partially encircling the side wall and/or spike(s) extending from the side wall or the floor.

Various embodiments of a frozen pet container of the present disclosure employs (1) a platform including a seat, and (2) frozen pet treat container of the present disclosure removably disposable within the seat or fixedly disposed within the seat.

For purposes of the present disclosure, the term “adjoin” and any tense/speech form thereof broadly encompasses any form of rigid physical contact between a frozen pet treat container and a frozen pet treat retainer including, but not limited to, an attachment, an integration, a coupling and a mounting of the frozen pet treat retainer within the frozen pet treat container.

The foregoing embodiments and other embodiments of the inventions of the present disclosure as well as various structures and advantages of the inventions of the present disclosure will become further apparent from the following detailed description of various embodiments of the inventions of the present disclosure read in conjunction with the accompanying drawings. The detailed description and drawings are merely illustrative of the inventions of the present disclosure rather than limiting, the scope of the inventions of the present disclosure being defined by the appended claims and equivalents thereof.

### BRIEF DESCRIPTION OF THE DRAWINGS

FIG. 1 illustrates an exemplary base embodiment of a frozen pet treat container in accordance with the present disclosure.

FIG. 2A illustrates an exemplary separable embodiment of a frozen pet treat container in accordance with the present disclosure.

FIG. 2B illustrates an exemplary integrated embodiment of a frozen pet treat container in accordance with the present disclosure.

FIGS. 3A-3C illustrate a first exemplary embodiment of the FIG. 2B integrated embodiment of a frozen pet treat container in accordance with the present disclosure.

FIG. 4A and 4B illustrate an exemplary embodiment of a frozen pet treat tray in accordance with the present disclosure.

FIGS. 5A-5C illustrate a second exemplary embodiment of the FIG. 2B integrated embodiment of a frozen pet treat contain in accordance with the present disclosure.

FIG. 6 illustrates exemplary embodiments of a frozen pet treat lid and a frozen pet treat seat in accordance with the present disclosure.

### DETAILED DESCRIPTION OF THE DRAWINGS

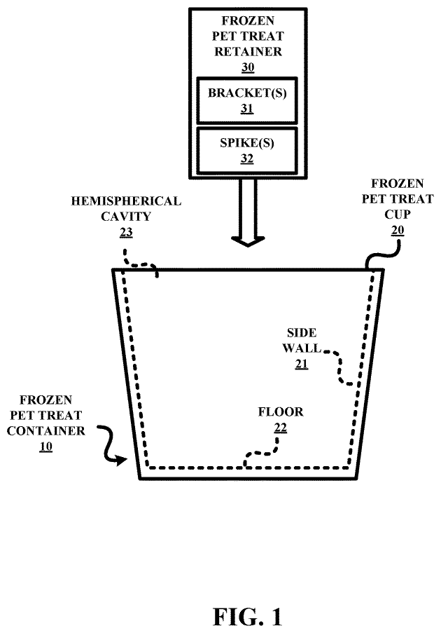

To facilitate an understanding of various aspects of the present disclosure, the following description of FIGS. 1-5 teaches the inventive principles of a frozen pet treat container and a frozen pet treat tray of the present disclosure. From this description, those having ordinary skill in the art will appreciate how to apply the various aspects of the present disclosure for making and using additional embodiments of frozen pet treat containers and frozen pet treat trays of the present disclosure.

Referring to FIG. 1, a frozen pet treat container 10 of the present disclosure employs an frozen pet treat cup 20 and a frozen pet retainer 30.

Frozen pet treat cup 20 includes a side wall 21 adjoined to a floor 22 defining a hemispherical cavity 23 configured to conditionally form a frozen pet treat within the frozen pet treat cup 20.

In practice, side wall 21 and floor 22 may have any configuration and/or any dimensions supportive of a desired volume of hemispherical cavity 23.

Also in practice, side wall 21 and floor 22 may have any material composition suitable for freezing a pet treat, such as, for example, rubber, steel and silicone.

Still referring to FIG. 1, frozen pet treat retainer 30 is disposed within the hemispherical cavity 23 and adjoined to side wall 21 and/or floor 22. Frozen pet treat retainer 30 is configured to interactively retain the frozen pet treat conditionally formed within the frozen pet treat cup 20.

In a first embodiment, frozen pet retainer 30 includes one or more bracket 31 with each bracket 31 partially or wholly encircling side wall 21 of frozen pet treat cup 20. A bracket 31 may be horizontal (e.g., parallel to the floor 22), and two or more brackets 31 may be in a parallel alignment or non-parallel alignment relative to floor 22.

In practice, bracket(s) 31 may have any configuration and/or any dimensions suitable for

partially or wholly encircling side wall 21 of frozen pet treat cup 20 without occupying a significant degree of space within hemispherical cavity 23.

Also in practice, bracket(s) 31 may have any material composition suitable for freezing a pet treat, such as, for example, rubber, steel and silicone, and bracket(s), and may have the same material composition or different material composition than side wall 21 and/or floor 22 of frozen pet treat cup 20.

Still referring to FIG. 1, in a second embodiment, frozen pet retainer 30 includes one or more spikes 32 with each spike extending from side wall 21 or floor 22 of frozen pet treat cup 20. A spike 32 may rigid or flexible.

In practice, spike(s) 32 may have any configuration and/or any dimensions suitable for

extending from side wall 21 or floor 22 of frozen pet treat cup 20 occupying a significant degree of space within hemispherical cavity 23.

Also in practice, spike(s) 32 may have any material composition suitable for freezing a pet treat, such as, for example, rubber, steel and silicone, and bracket(s) may have the same material composition or different material composition than side wall 21 and/or floor 22 of frozen pet treat cup 20.

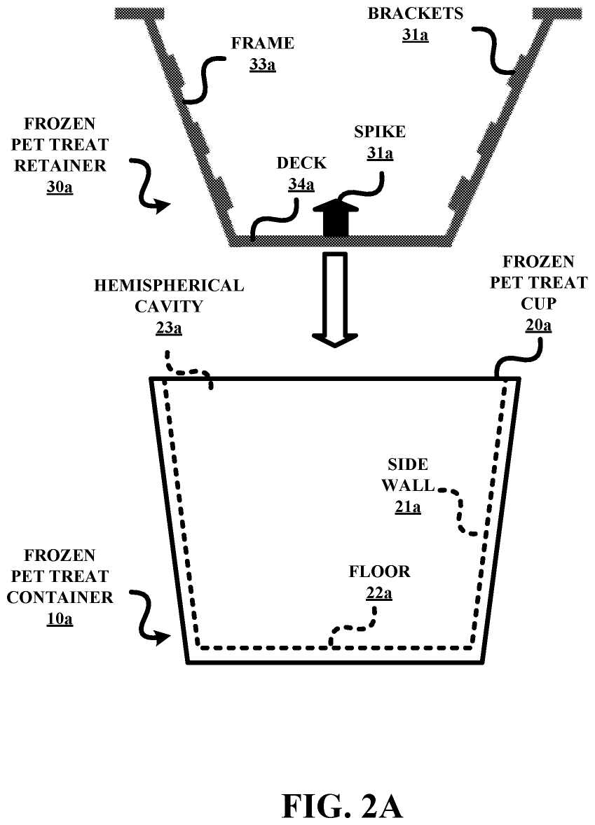

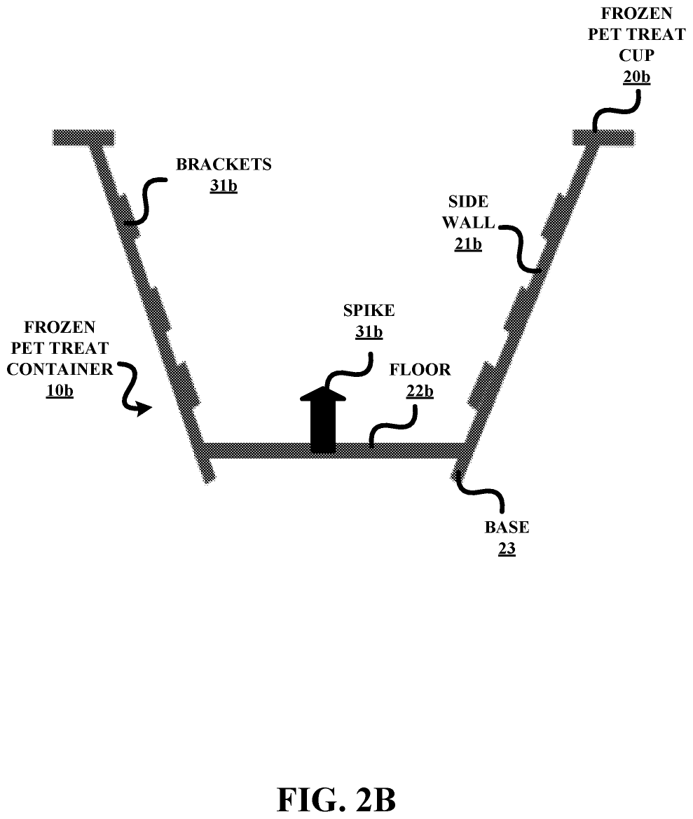

FIG. 2A illustrates a separable embodiment of frozen pet treat container 10a, and FIG. 2B illustrates an integrated embodiment of frozen pet treat container 10b.

Referring to FIG. 2A, frozen pet treat container 10a employs a frozen pet treat cup 20a including a side wall 21a adjoined to a floor 22a defining a hemispherical cavity 23a configured to conditionally form a frozen pet treat within the frozen pet treat cup 20a.

Frozen pet treat container 10a further employs a frozen pet treat retainer 30a including brackets 31a encircling a frame 33a and a spike 32a extending from a deck 34a. In practice, frozen pet retainer 30a is friction fitted within the hemispherical cavity 23a whereby brackets 31a encircle side wall 21a of frozen pet treat cup 20a and a spike 32a extends from floor 22b. Also in practice, frozen pet retainer 30a may be removed anytime for cleaning or replacement

Referring to FIG. 2B, frozen pet treat container 10b employs a frozen pet treat cup 20b including a side wall 21b adjoined to a floor 22b defining a hemispherical cavity 23b configured to conditionally form a frozen pet treat within the frozen pet treat cup 20b.

Frozen pet treat container 10a further employs a frozen pet treat retainer 30b integrated with cup 20b whereby brackets 31b encircle side wall 21b and a spike 32b extend from floor 22b.

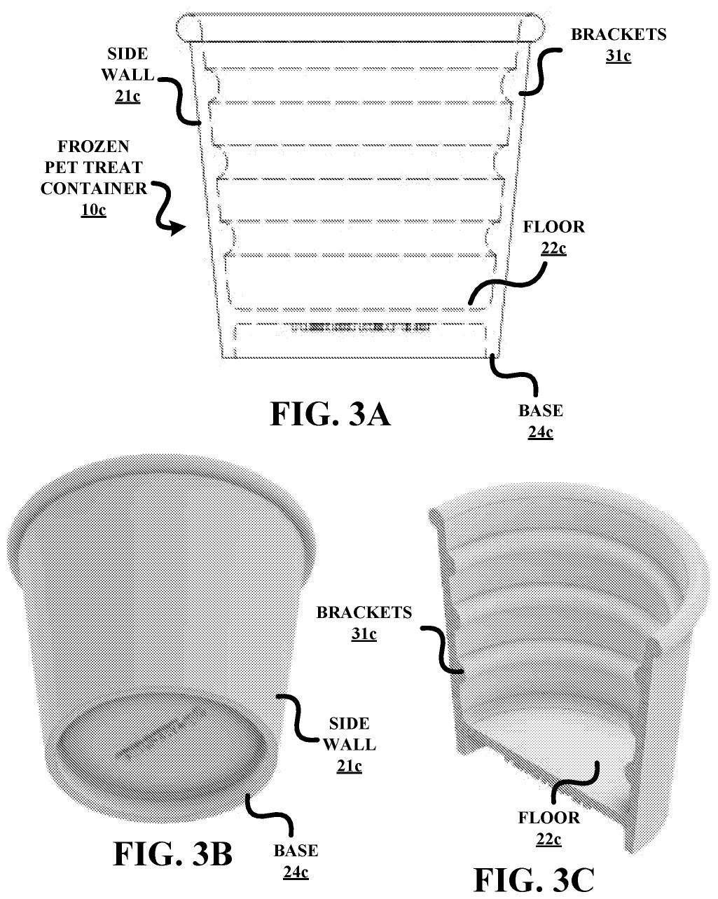

FIG. 3A-3C illustrates an example of the integrated embodiment 10c of the frozen pet container 10b of FIG. 2A. Frozen pet treat container 10c employs a frozen pet treat cup 20c including a side wall 21c adjoined to a floor 22c defining a hemispherical cavity 23c configured to conditionally form a frozen pet treat within the frozen pet treat cup 20c. Additionally, a base 24c is provided for stabilizing an upright standing of frozen pet treat container 10c.

Frozen pet treat container 10c further employs a frozen pet treat retainer 30c integrated with cup 20c whereby brackets 31b encircle side wall 21b.

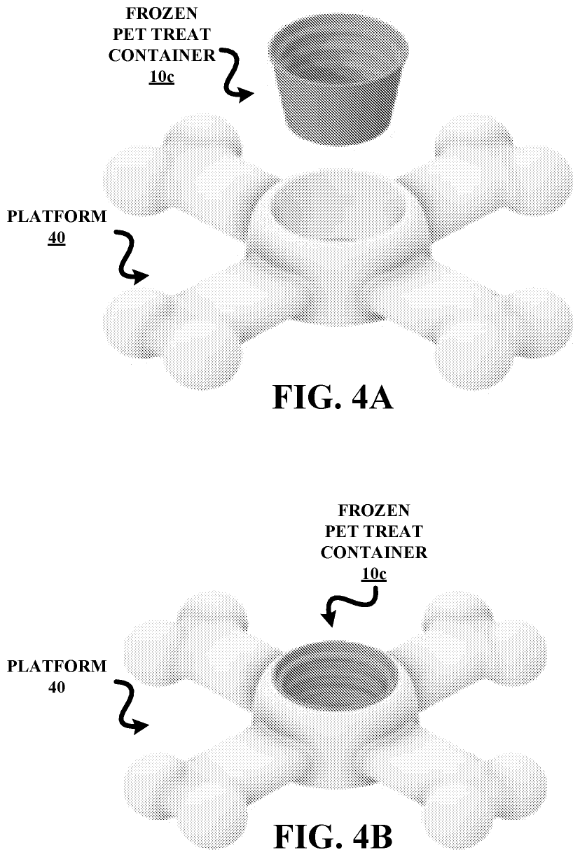

In practice, frozen pet treat container 10c may be seated within a platform, such as, for example, a platform 40 as shown in FIGS. 4A and 4B.

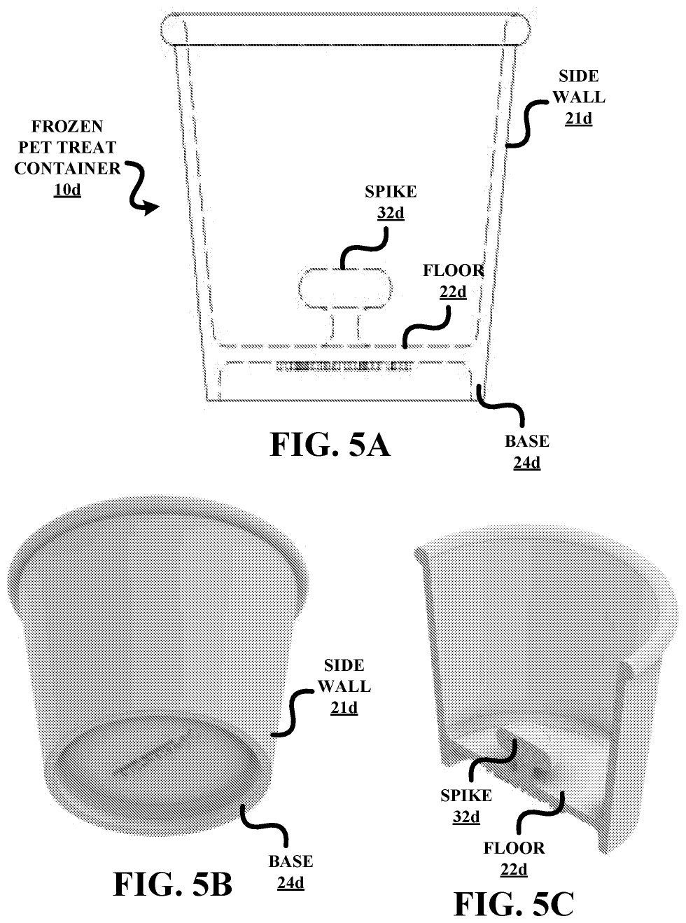

FIG. 5A-5C illustrates an example of the integrated embodiment 10d of the frozen pet container 10b of FIG. 2A. Frozen pet treat container 10d employs a frozen pet treat cup 20d including a side wall 21d adjoined to a floor 22d defining a hemispherical cavity 23d configured to conditionally form a frozen pet treat within the frozen pet treat cup 20d. Additionally, a base 24d is provided for stabilizing an upright standing of frozen pet treat container 10d.

Frozen pet treat container 10d further employs a frozen pet treat retainer 30c integrated with a spike 32d extends from floor 22d.

In practice, frozen pet treat container 10d may be seated within a platform, such as, for example, platform 40 as shown in FIGS. 4A and 4B.

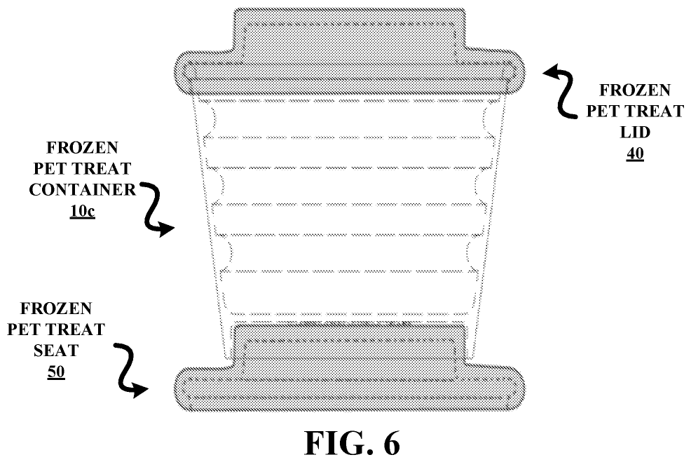

FIG. 6 illustrates a frozen pet treat lid 40 and a frozen pet treat seat 50 that may be individually or collectively utilized with a frozen pet treat container of the present disclosure, such as, for example, frozen pet treat container 10c as shown.

Having described preferred and exemplary embodiments of novel and inventive frozen pet treat containers of the present disclosure (which embodiments are intended to be illustrative and not limiting), it is noted that modifications and variations can be made by persons having ordinary skill in the art in light of the teachings provided herein, including the FIGS. 1-7. It is therefore to be understood that changes can be made in/to the preferred and exemplary embodiments of the present disclosure which are within the scope of the embodiments disclosed herein.

1. A frozen pet treat container, comprising:
a frozen pet treat cup including a side wall adjoined to a floor defining a hemispherical cavity configured to conditionally form a frozen pet treat within the frozen pet treat cup; and
a frozen pet treat retainer disposed within the hemispherical cavity and adjoined to at least one of the side wall and the floor, wherein the frozen pet treat retainer is configured to interactively retain the frozen pet treat conditionally formed within the frozen pet treat cup.

2. The frozen pet treat container of claim 1, wherein the frozen pet treat retainer includes at least one at least one bracket partially encircling the side wall.

3. The frozen pet treat container of claim 1, wherein the frozen pet treat retainer includes at least one at least one spike extending from at least one of the side wall or the floor.

4. A frozen pet treat tray, comprising:
a platform including a seat; and
a frozen pet treat container removably disposable within the seat or fixedly disposed within the seat, where the frozen pet treat container includes:
a frozen pet treat cup including a side wall adjoined to a floor defining a hemispherical cavity configured to conditionally form a frozen pet treat within the frozen pet treat cup; and
a frozen pet treat retainer disposed within the hemispherical cavity and adjoined to at least one of the side wall and the floor, wherein the frozen pet treat retainer is configured to interactively retain the frozen pet treat conditionally formed within the frozen pet treat cup.

5. The frozen pet treat tray of claim 1, wherein the frozen pet treat retainer includes at least one at least one bracket partially encircling the side wall.

6. The frozen pet treat tray of claim 1, wherein the frozen pet treat retainer includes at least one at least one spike extending from at least one of the side wall or the floor.
